(19) United States
(12) Patent Application Publication
(10) Pub. No.: US 2005/0236505 A1
(43) Pub. Date: Oct. 27, 2005

(54) Operating device for leader member and magnetic tape cartridge

(75) Inventor: Hiroyuki Tsuchiya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/113,985

(22) Filed: Apr. 26, 2005

(30) Foreign Application Priority Data
Apr. 27, 2004 (JP) P.2004-131070

(51) Int. Cl. G11B 15/67; G11B 23/107

(52) U.S. Cl. 242/332.4; 242/348.2

(57) ABSTRACT

A device for operating the leader member performs at least one of pullout of the leader member from the lock unit of the magnetic tape cartridge and insertion of the leader member into the lock unit. The device has a base to apply a force to operate the leader member, a swingable member swingably supported to the base, and an elastically-biased unit biased toward the center of swinging motion of the swingable member. The swingable member has an engagement portion at a side of one end of the swingable member. The leader member is detachably engaged to the engagement portion.

This application is based on Japanese Patent application JP 2004-131070, filed Apr. 27, 2004, the entire content of which is hereby incorporated by reference. This claim for priority benefit is being filed concurrently with the filing of this application.

### BACKGROUND OF THE INVENTION

1. Technical Field of the Invention

The present invention relates to an operating device for the leader member of a magnetic tape cartridge to pull out and/or insert the leader member into/from its case. The invention also relates to this magnetic tape cartridge. Especially, the invention relates to a technique for making uniform forces necessary to perform such operations.

2. Description of the Related Art

Magnetic tape cartridges each is equipped with a single reel around which magnetic tape used as a data record/playback medium for computers and so on is wound have been heretofore known. The reel is housed in a case. A leader member such as a leader pin, leader block, or leader tape is mounted at the leading edge of the magnetic tape. Pullout unit mounted on the side of the tape drive pulls out the leader member out of the magnetic tape cartridge, and the magnetic tape firmly fixed to the leader member is wound on a take-up reel on the side of the tape drive (see, for example, JP-A-2002-367333).

Standards stipulate that the force (pullout force) necessary to pull the leader pin mounted to the front end of magnetic tape out of a lock member in the case of the aforementioned magnetic tape cartridge and the force (insertion force) necessary to bring the leader pin into engagement with the lock member within the case be set within predetermined ranges.

However, actual measurements of these forces using a load cell have shown that measured forces vary greatly among these forces. It has been impossible to measure the forces accurately and stably. After conducting discussions earnestly, the inventors have found that the route in which the leader pin moves when the pin comes into or out of engagement with a leaf spring mounted to the case is not constant and, consequently, the force applied to the leader pin is unstable.

The direction in which the leader pin is pulled out or the direction in which the leader pin is inserted into the case may vary slightly according to differences among individual products of magnetic tape cartridge. The route in which the leader pin travels is affected thereby and may vary greatly. Therefore, the pullout force and insertion force result in variations. Consequently, it is impossible to operate the leader pin stably.

The results of simulations of the route in which the leader pin moves during pullout of the pin are shown in FIGS. 7A-7C. When the leader pin 1 is in a case accommodation position (position A) indicated by broken lines as shown in FIG. 7A, the leaf spring 3 is in the position indicated by a broken line. Under this condition, if the leader pin 1 is pulled out, the pin 1 raises the spring 3 as indicated by a solid line (position B). If the pin 1 is pulled out further as shown in FIG. 7B (position C), the leaf spring 3 is elastically returned to its original state while the pin 1 is in contact with arc-shaped wall surfaces 5A and 7A formed in an upper half 5 and a lower half 7. Consequently, the pin 1 moves obliquely downwardly as viewed in the figure. If the pin 1 is pulled out further as shown in FIG. 7C (positions D and E), the pin 1 disengages from the leaf spring 3. In this way, the route of movement of the pin 1 serpentines from the position A to D. If any of various conditions such as the direction of pullout differs slightly, the serpentine route of movement is varied greatly. As a result, there arises the problem that the pullout force is not constant. A similar problem takes place when the leader pin 1 is inserted into the case. The insertion force is not-constant but varies.

In view of the foregoing circumstances, the present invention has been made.

### SUMMARY OF THE INVENTION

It is an object of the invention to provide an operating device for a leader member of a magnetic tape cartridge such that the leader member can be operated at a constant force at all times by preventing variations in the force necessary to pull out the leader member from a lock unit within the case and in the force necessary to insert the leader member into the lock unit. It is another object of the invention to provide the magnetic tape cartridge in which the leader member is thus inserted and pulled out at adjusted force.

The above-described objects of the present invention are achieved by the following configurations.

(1) An operating device for a leader member in a magnetic tape cartridge having a case in which a single reel on which magnetic tape is wound is rotatably housed, the leader member mounted at a side of one end of the magnetic tape, and lock unit to which the leader member is engaged within the case, the device performing at least one of pullout of the leader member from the lock unit and insertion of the leader member into the lock unit, and the device comprising: a base for applying a force to operate the leader member; a swingable member swingably supported to the base and having an engagement portion at a side of one end of the swingable member, the leader member being detachably engaged to the engagement portion; and elastically-biased unit biased toward the center of swinging motion of the swingable member.

With this operating device for the leader member, the elastically-biased unit is biased toward the center of range of swinging motion of the swingable member under the condition where the leader member is engaged to the engagement portion of the swingable member swingably supported to the base. This makes it possible to operate the leader member at a constant force when the leader member is pulled out of the lock unit in the case or inserted into the lock unit.

(2) An operating device for a leader member as set forth in above (1) and further characterized in that the elastically-biased unit comprises a pair of spring members mounted along the direction of swinging motion at both sides of the swingable member.

In this operating device for a leader member, the elastically-biased unit is made up of the spring members. Consequently, the spring force can be adjusted easily. Furthermore, the structure can be made simpler.

(3) An operating device for a leader member as set forth in above (2) and further characterized in that the lock unit is a leaf spring capable of elastically deforming when touching a part of the leader member that the elastically-biased unit is smaller in spring constant than the leaf spring.

In this operating device for a leader member, the elastically-biased unit is smaller in spring constant than the leaf spring of the lock unit. Therefore, when the leader member is operated, mainly the spring members of the elastically-biased unit are stretched or shrunk. The leader pin can be operated without producing large deformation of the leaf spring. The force required to pull out the leader member fixed inside the case and the force required to insert the leader member into the leaf spring can be made constant.

(4) An operating device for a leader member as set forth in any one of above (1) to (3) and further characterized in that the base has load detection unit for measuring the force to pull out or insert the leader member.

With this operating device for a leader member, the force to pull out the leader member and the force to insert the member can be quantitatively grasped by the load detection unit. For example, a check can be made to see if the forces are within a prescribed range.

(5) A magnetic tape cartridge for use with an operating device for a leader member as set forth in any one of (1) to (4), wherein a force to pull out the leader member from the lock unit and a force to insert the leader member into the lock unit are measured using the device, and wherein at least one of the forces is set to within a range from 0.5 to 2.0 N.

With this magnetic tape cartridge, when the leader member is pulled out from the lock unit or inserted into the lock unit, the operation can be carried out at a force lying within a predetermined range. The situation where the force is not strong enough to lock the pin sufficiently or the force is excessive so that the pin cannot be easily unlocked can be prevented.

With the operating device for a leader member in accordance with the present invention, the force to pull out the leader member of the magnetic tape cartridge from the lock unit within the case and the force to insert the leader member into the lock unit are prevented from varying. In consequence, the leader member can be operated at a constant force at all times.

### BRIEF DESCRIPTION OF THE DRAWINGS

FIG. 1 is a perspective view of one embodiment of a magnetic tape cartridge.

FIG. 2 is an exploded view of the tape cartridge shown in FIG. 1.

FIG. 3 is a schematic enlarged view of the vicinities of the opening in the tape cartridge shown in FIG. 1.

FIG. 4A is a plan view of an operating device for a leader member and FIG. 4B is a side view partially in cross section of the leader member shown in FIG. 4A;

FIG. 5A is a view illustrating the manner in which the operating device shown in FIGS. 4A and 4B is pulled to the left to pull out a leader pin, and in which the pin has been swung in an upward direction as viewed in the figure, and FIG. 5B is a view similar to FIG. 5A, but in which the pin has been swung in a downward direction as viewed in the figure.

FIG. 6 is a schematic structural view showing one example of application of an operating device according to the invention to a drive device.

FIGS. 7A, 7B, and 7C are diagrams showing the results of simulations of a route in which the related art leader pin moves when the pin is pulled out.

### DETAILED DESCRIPTION OF THE INVENTION

Preferred embodiments of a leader member-operating device according to the present invention are hereinafter described in detail with reference to the drawings.

A leader member-operating device according to the present invention is used to perform an operation on a magnetic tape cartridge having a case, a leader member, and a lock unit to which the leader member is engaged within the case. A single reel on which magnetic tape is wound is rotatably housed in the case. The leader member is mounted at the side of one end of the tape. In particular, the operating device is used to pull out the leader member from the lock unit and to insert the leader member into the lock unit.

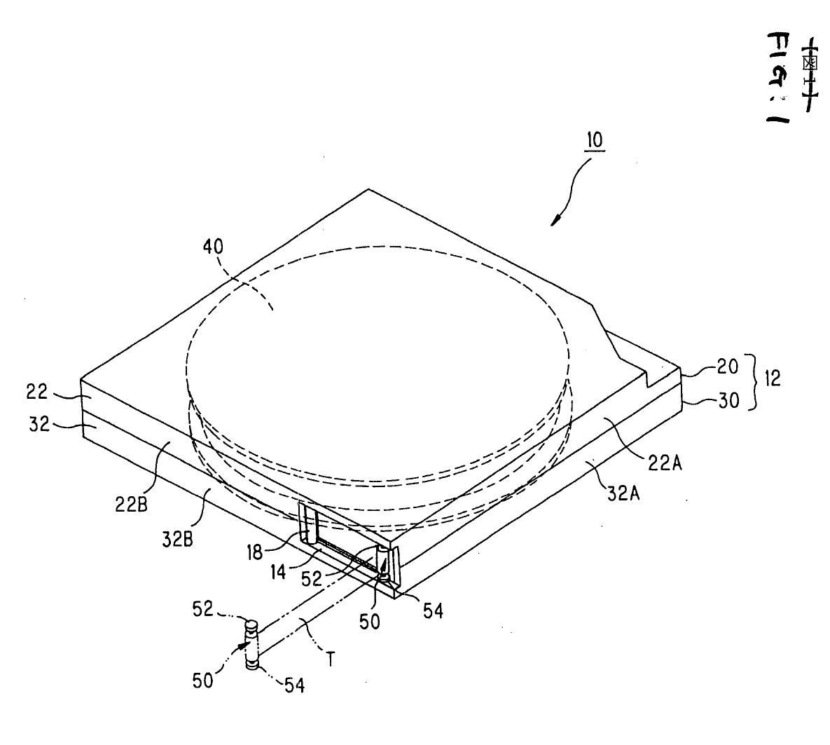

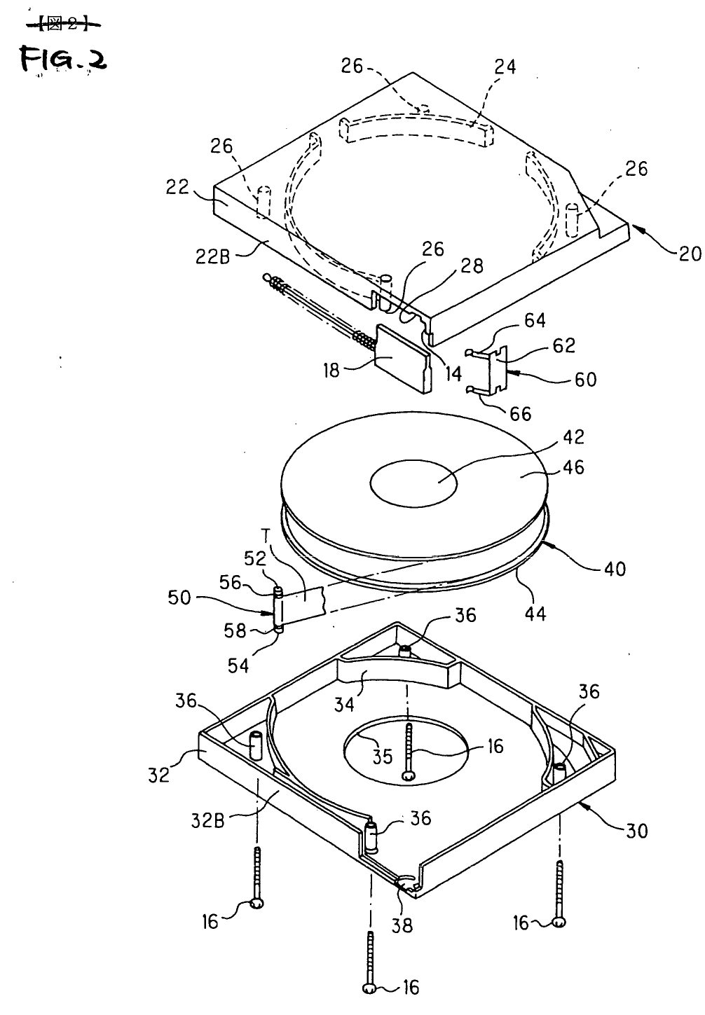

First, the magnetic tape cartridge with which the leader member-operating device is used is described. FIG. 1 is a perspective view of the magnetic tape cartridge. FIG. 2 is an exploded view of the tape cartridge shown in FIG. 1.

As shown in FIGS. 1 and 2, the magnetic tape cartridge 10 has a case 12 made of a synthetic resin. The case 12 is made up of an upper case 20 and a lower case 30 having peripheral walls 22 and 32, respectively. The upper and lower cases are joined together such that their peripheral walls abut against each other to form a substantially rectangular box-like structure. In particular, a plurality of non-perforated bosses (four in the illustrated example) 26 protrude from the inner surface of the upper case 20. Perforated bosses 36 which are equal in number with the bosses 26 protrude from the inner surface of the lower case 30. When the peripheral wall 22 of the upper case 20 and the peripheral wall 32 of the lower case 30 are brought into contact with each other, the bosses 26 abut against the bosses 36, whereby the spaces in the corresponding bosses are placed in communication with each other. Accordingly, the upper case 20 and lower case 30 are joined together by inserting screws 16 into the bosses 26 from the lower surface of the lower case 30 via the bosses 36.

A single reel 40 on which magnetic tape T is wound is rotatably housed inside the case 12. The tape T is an information record/read medium. That is, loose motion-limiting walls 24 and 34 which are substantially cylindrical are formed on the inner surfaces of the upper case 20 and lower case 30, respectively, and stand upright substantially vertically symmetrically. The reel 40 is accommodated within a space formed by the loose motion-limiting walls 24 and 34. A circular gear opening 35 is formed in the center of the lower case 30. A reel gear (not shown) mounted annularly on the lower surface of the reel 40 is exposed from the gear opening 35.

The reel 40 is composed of a cylindrical reel hub 42 disposed in the center and a lower flanged portion 44 projecting radially from the outer surface of the lower end of the reel hub. The reel hub 42 and the lower flanged portion 44 are integrally molded from a synthetic resin. An upper flanged portion 46 that is identical in shape with the lower flanged portion 44 is bonded to the upper end of the reel hub by ultrasonic welding. The magnetic tape T is wound around the reel hub 42.

As shown also in FIG. 3, the side walls 22B and 32B are cut out near the right front corner of the magnetic tape cartridge 10 to form an opening 14. This opening 14 is used to pull out the magnetic tape T to the outside, the tape T being wound around the reel 40. When the cartridge 10 is not in use, the opening is closed by a shutter member 18, which is located inside the side walls 22B and 32B and moves along the side walls 22B and 32B.

Recesses 28 and 38 which assume a U-shaped form when viewed within a plane are formed in the inner surfaces of the upper case 20 and lower case 30 near the corner portion (opening 14). A leader pin 50 that is a leader member to be engaged to an operating device (described in detail later) mounted to a tape drive or inspection instrument when the operating device pulls out the magnetic tape T has an upper-end portion 52 and a lower-end portion 54. Annular grooves 56 and 58 in which the operating device will be engaged are formed respectively between the upper-end portion 52 of the pin 50 and the body portion of the pin to which the magnetic tape T is firmly fixed and between the lower-end portion 54 of the pin 50 and the body portion.

A leaf spring 60 that is a elastically deformable lock unit is mounted to the magnetic tape cartridge 10 as shown in FIGS. 2 and 3 to press the upper-end portion 52 and lower-end portion 54 toward arc-shaped wall surfaces 28A and 38A, respectively, of the recesses 28 and 38 at a given pressure to prevent the upper-end portion 52 and lower-end portion 54 of the pin 50 from disengaging from the recesses 28 and 38, respectively.

The leaf spring 60 is composed of a body portion 62 in the form of a flat plate and elongated acting portions 64 and 66. The body portion 62 is engaged and held inside front walls 22A and 32A. The acting portions 64 and 66 integrally extend by a given length toward the opening 14 from the upper and lower ends, respectively, of the body portion 62. The front end of each of the acting portions 64 and 66 is bent inwardly (rearwardly in FIG. 3) into a V-shaped form as viewed within a plane. The bent front ends abut against the upper-endportion 52 and lower-end portion 54, respectively, of the leader pin 50.

The acting portions 64 and 66 of the leaf spring 60 press the upper-end portion 52 and lower-end portion 54 of the leader pin 50 toward the arc-shaped wall surfaces 28A and 38A, respectively, at a given pressure. Consequently, the leader pin 50 is held down and prevented from disengaging from the recesses 28 and 38. When the pin 50 is pulled out from the recesses 28 and 38 or pressed into them, the acting portions 64 and 66 appropriately deform elastically, permitting movement of the pin 50. Therefore, the pressing force of the leaf spring 60 which is a force resisting pullout is so set that the force does not exceed the pullout force of the operating device, i.e., the upper limit of the pushing force (force resisting pullout) of the leaf spring 60 is substantially identical with the pullout force of the operating device.

During manufacturing of the magnetic tape cartridge 10, the force to pull out the leader pin 50 from the recesses 28 and 38 and the force to insert the pin into the recesses 28 and 38 have their preferable range of 0.5 to 2.0 N, for example. To satisfy the range requirement, it is necessary that repeated measurements prove that pullout and insertion are done with a substantially constant force. However, with the related art measuring instrument, in a case where the same magnetic tape cartridge is repeatedly measured, the pullout force and insertion force for the leader member result in great variations, making it impossible to perform accurate measurements.

Accordingly, the inventors made the following leader member-operating device and repeatedly measured the force to pull out the leader member from the magnetic tape cartridge 10 and the force to insert the leader member into the cartridge. Stable and substantially constant values were obtained at all times. This operating device for the leader member is described in detail below.

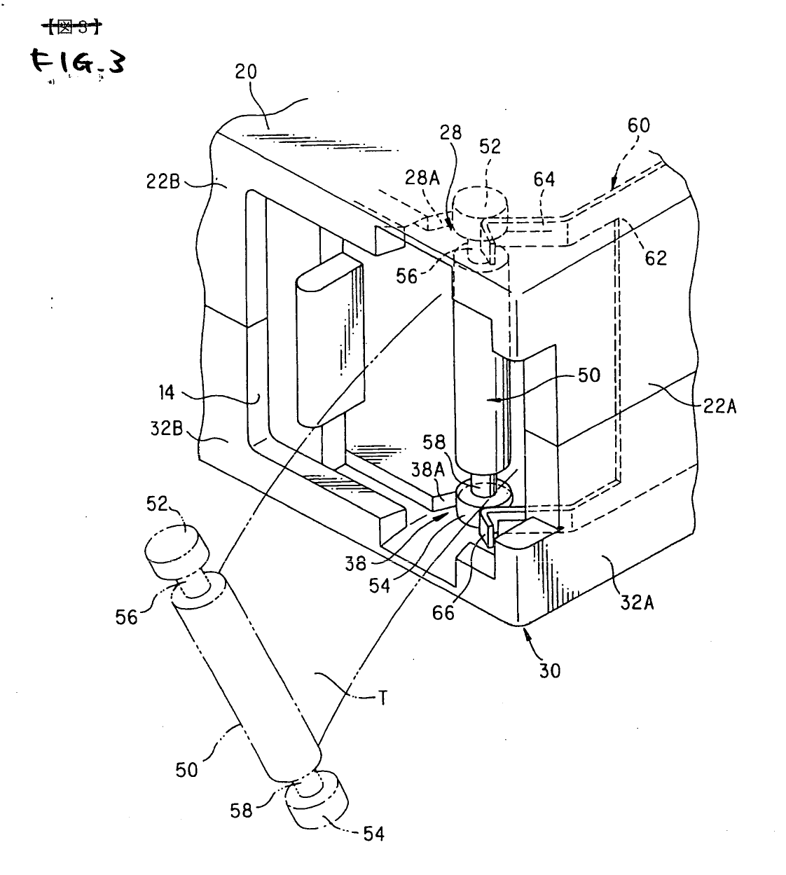

FIG. 4A is a plan view of the operating device for the leader member. FIG. 4B is a side view partly in cross section of the device. This operating device 100 is mainly composed of a base 71 for applying a force to operate the leader member, a swingable member 77 held to the base 71 so as to be swingable around a pivot 73, and a elastically-biased unit 79 biased toward the center of swinging motion of the swingable member 77. The swingable member 77 has an engagement portion 75 at a side of one end of the swingable member 77. The leader pin 50 that is a leader member is detachably engaged to the engagement portion 75 of the swingable member 77. A load cell 81 acting as a load detection unit is connected with the base 71.

The engagement portion 75 at one end of the swingable member 77 has a hook 83 in which annular grooves 56 and 58 formed in the leader pin 50 are engaged. The engagement portion 75 has a base-end portion connected with the swingable member 77, which in turn is rotatably supported to the base 71 via a bearing 85. The elastically-biased unit is mounted to the other end of the swingable member 77 that is on the opposite side of the engagement portion 75. The elastically-biased unit has a pair of spring members 87a and 87b mounted along the direction of swinging motion at both sides of the swingable member 77. The spring members 87a and 87b are so biased as to push against the side surfaces of the swingable member 77. The spring members bias the swingable member 77 toward the center position of swinging operation performed about the pivot 73, i.e., toward the center of the swinging motion. A hole 91 is formed at the end of the base 71 on the opposite side of the engagement portion 75 to permit connection with a measuring terminal 89 of the load cell 81. The load cell 81 is connected with a member (not shown) for transmission of an operating force via a hole 93 used for fixing purposes. As a result, the operating force of the leader pin 50 can be measured.

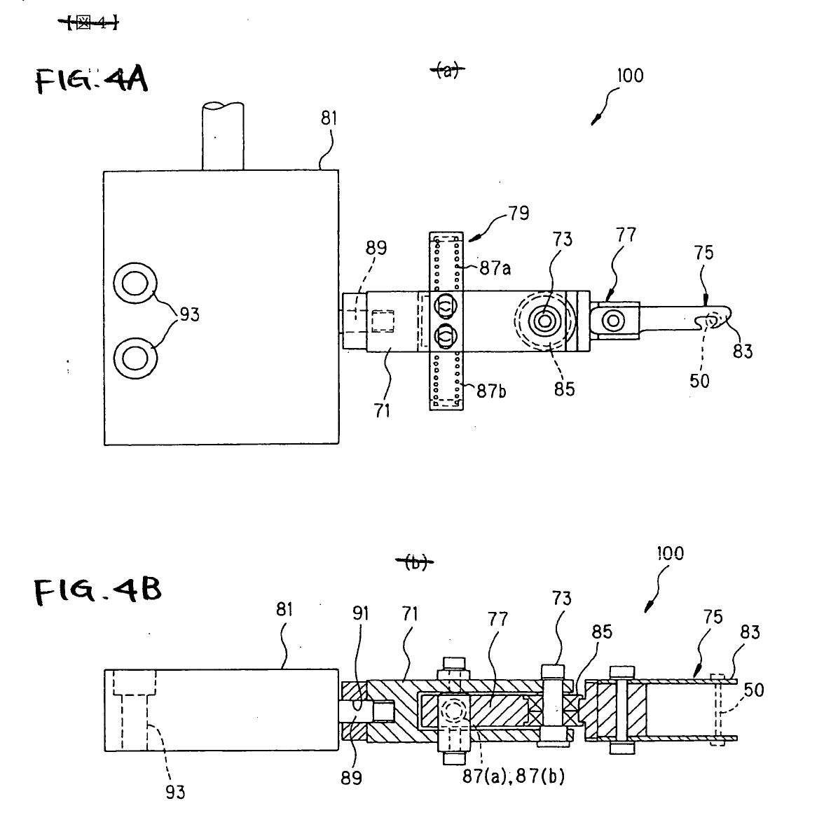

The operation of the leader member-operating device 100 of the construction described above is next described. FIGS. 5A and 5B show the manner in which the operating device is pulled to the left as viewed in the figures to pull out the leader pin 50. In FIG. 5A, the pin has been swung in an upward direction. In FIG. 5B, the pin has been swung in a downward direction.

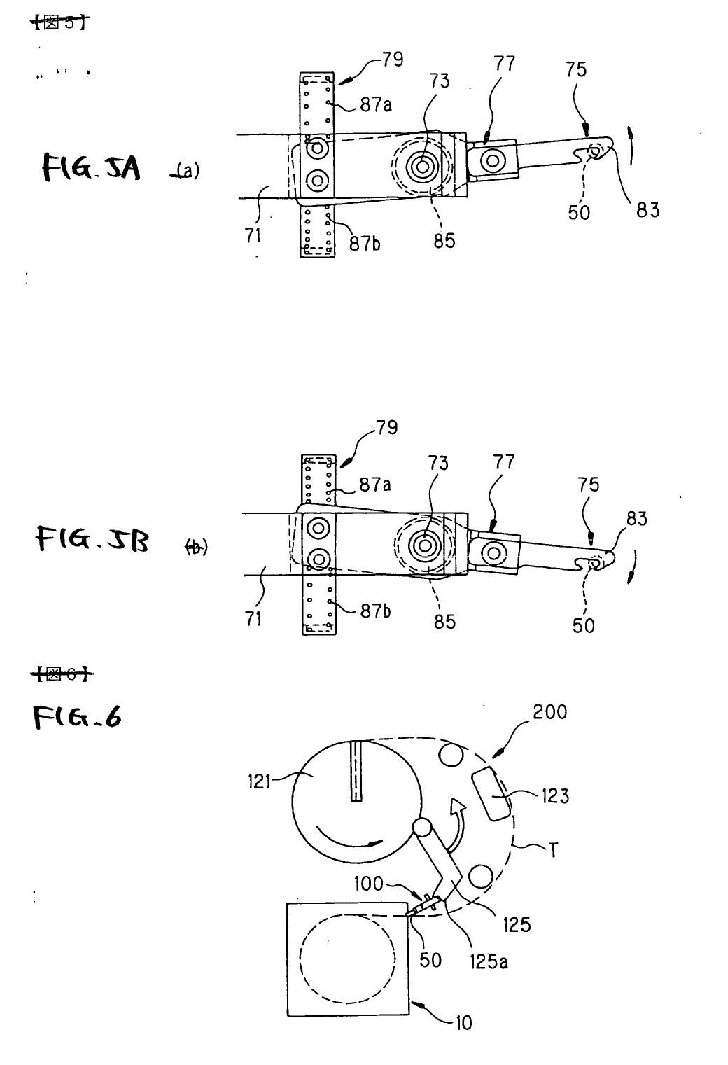

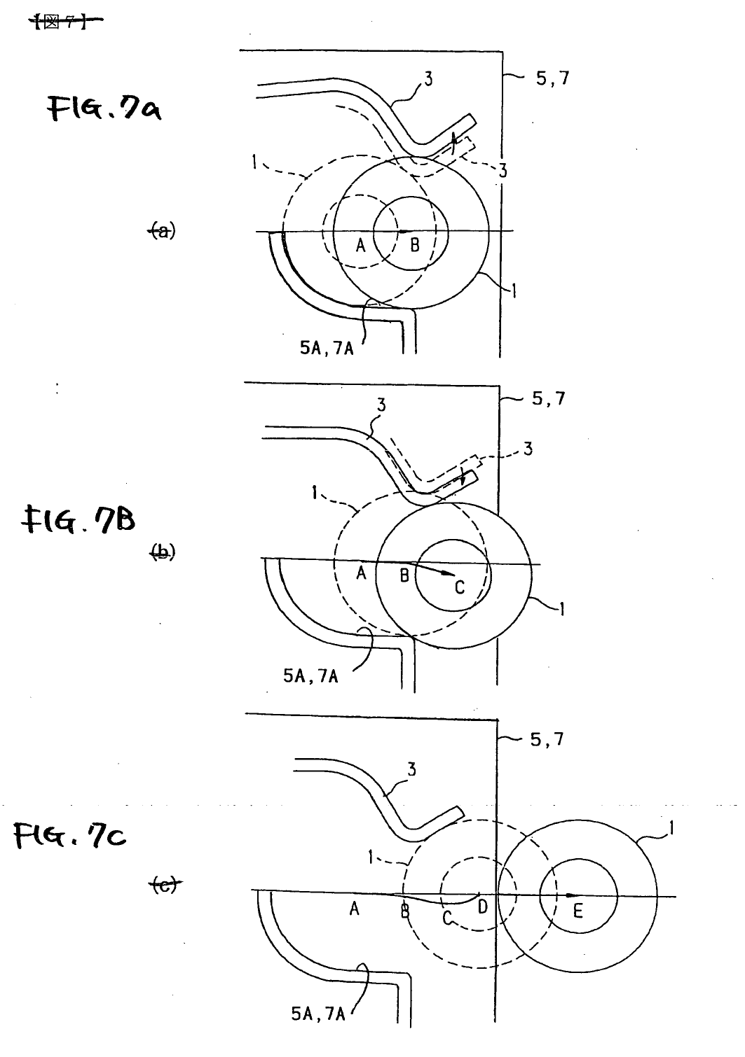

In this way, the swingable member 77 can swing around the pivot 73. Furthermore, the swingable member 77 can be returned to the neutral position by the elastic repulsive force of the spring members 87a and 87b. Accordingly, in a case where the route of movement of the leader pin deviates from a straight line because of the presence of the leaf spring that is a unit for locking the magnetic disk cartridge as shown in the above-cited FIG. 7, the spring members 87a and 87b which are smaller in spring constant than the leaf spring 60 are stretched or shrunk so as to swing the swingable member 77. Consequently, the leaf spring 60 does not deform greatly; mainly the spring members 87a and 87b which are elastically-biased unit deform. Thus, the leader pin 50 is operated smoothly. That is, if the direction of pullout or direction of insertion deviates, the spring members 87a and 87b of the elastically-biased unit are stretched or shrunk so as to absorb the deviation. The leader pin 50 can be operated at a constant force at all times.

Therefore, in a case where the leader pin 50 is pulled out of the leaf spring 60 that is the unit for locking the magnetic tape cartridge 10 or where the pin is inserted into the leaf spring 60, the operation can be carried out at a constant force at all times. When the pullout and insertion forces are measured, stable measurement values are obtained. Produced variations can be reduced greatly.

In the case of the above-described magnetic tape cartridge, the spring force of the spring members of the elastically-biased unit is preferably 0.01 to 0.1 N/mm, more preferably about 0.05 N/mm. Where the spring force is set to within this range, stable measurement values are obtained. It is possible to make a good decision as to whether the pullout force and insertion force are within the range of 0.5 to 2.0 N that is said to be a preferable range.

The above-described device 100 for operating the leader member can be used for a drive device for reading and writing data, as well as for an inspection instrument for measuring the operating force.

FIG. 6 is a schematic structural view showing one example of application of this operating device to the drive device. The drive device 200 records and reads data by a read/write head 123 when magnetic tape T payed out from a magnetic tape cartridge 10 is being wound around a take-up reel 121.

The drive device 200 has an arm 125 to which a leader pin 50 is engaged, the pin 50 being connected to an end of the magnetic tape T. The arm 125 rotates to thereby guide the pin to the take-up reel 121. The operating device 100 is mounted to the front end 125a that is on the opposite side of the center of rotation of the arm 125.

With the drive device 200 of this construction, the leader pin 50 can be pulled out from the magnetic tape cartridge 10 or inserted into it at a constant force at all times. A stable chucking operation can be performed.

In the present embodiment, the operating device capable of being operated in both directions to pull out and insert the leader pin 50 is shown as one example. The operating device may be so constructed within the scope of the present invention that the device can be operated in only one direction for only one of pullout and insertion of the pin.

The force to pull out the leader pin 50 from the lock unit of the magnetic tape cartridge and the force to insert the pin into the lock unit are measured using the leader member-operating device as described above. The measured value of at least one of the two kinds of forces is set to within the range of 0.5 to 2.0 N. Where the leader pin 50 is pulled out from the leaf spring 60 that is a lock unit or the pin 50 is inserted into the leaf spring 60, this operation can be carried out with a force lying within the given range. The situation where the force is not strong enough to lock the pin sufficiently or the force is excessive and the pin cannot be easily unlocked can be prevented.

1. An operating device for a leader member of a magnetic tape cartridge, comprising:
a base that applies a force to operate the leader member;
a swingable member swingably supported to the base and having an engagement portion that detachably engages with the leader member at one end of the swingable member; and
an elastically-biased unit biased toward a center of swinging motion of the swingable member.

2. The operating device according to claim 1, wherein the elastically-biased unit is a pair of spring members mounted along a direction of swinging motion at both sides of the swingable member.

3. The operating device according to claim 2, wherein the pair of spring members has a spring force of 0.01 to 0.1 N/mm.

4. The operating device according to claim 2, wherein the pair of spring members has a spring force of about 0.05 N/mm.

5. The operating device according to claim 1, wherein the base has a load detection unit that measures a force to pull out or insert the leader member.

6. A combination of a magnetic tape cartridge and an operating device, wherein
the magnetic tape cartridge comprises a magnetic tape, a single reel around which the magnetic tape is wound, a case in which the single reel is rotatably housed, a leader member attached to one end of the magnetic tape, and a lock unit to which the leader member is engaged within the case, and
the operating device comprises a base that applies a force to operate the leader member, a swingable member swinqably supported to the base and having an engagement portion that detachably engages with the leader member at one end of the swingable member, and an elastically-biased unit biased toward a center of swinging motion of the swingable member so as to pull out the leader member from the lock unit or insert the leader member into the lock unit.

7. The combination according to claim 6, wherein the elastically-biased unit is a pair of spring members mounted along a direction of swinging motion at both sides of the swingable member.

8. The combination according to claim 7, wherein the lock unit is a leaf spring that abuts against a part of the leader member and elastically deforms, and the spring members of the elastically-biased unit are smaller in spring constant than the leaf spring.

9. The combination according to claim 6, wherein the base has a load detection unit that measures a force to pull out or insert the leader member.

10. The combination according to claim 6, wherein at least one of a force to pull out the leader member from the lock unit and a force to insert the leader member into the lock unit is set within a range of 0.5 to 2.0 N.
